(19) United States
(12) Patent Application Publication
(10) Pub. No.: US 2003/0220994 A1
(43) Pub. Date: Nov. 27, 2003

(54) Wireless network access system and method

(76) Inventor: Chunrong Zhu, Portland, OR (US)

Correspondence Address: KOLISCH HARTWELL, P.C., 520 S.W. YAMHILL STREET, SUITE 200, PORTLAND, OR, 97204, US

(21) Appl. No.: 10/377,284

(22) Filed: Feb. 27, 2003

Related U.S. Application Data
(60) Provisional application No. 60/361,020, filed on Feb. 28, 2002.

(51) Int. Cl. G06F 15/173

(52) U.S. Cl. 709/223; 709/249

(57) ABSTRACT

A system and method are provided for enabling a user to access a plurality of local wireless computer networks from a mobile computing device, using a single wireless access account to pay for the access charges incurred at the plurality of local wireless computer networks.

### CROSS-REFERENCE TO RELATED APPLICATION

This application claims priority to U.S. Provisional Patent Application Serial No. 60/361,020, filed Feb. 28, 2002, the entire disclosure of which is herein incorporated by reference.

### TECHNICAL FIELD

The present invention relates generally to computer networks, and more particularly to systems and methods for accessing a wireless computer network.

### BACKGROUND

Wireless computer networks have grown in popularity in recent years because they provide a user the freedom to access a network from a mobile computing device from a variety of locations. Unfortunately, current wireless networking technologies do not permit computer users to seamlessly shift a connection from a first wireless LAN to a second wireless LAN when moving from place to place. Rather, the user must disconnect from a first wireless LAN and connect anew to a second wireless LAN. In each location, the user may be required to pay an access fee for the privilege of using the wireless network for a predetermined period of time. The payment of access fees to different local area networks is time consuming and expensive for the user, since the user may not use all of the access time for which the user paid.

### SUMMARY OF THE INVENTION

A system and method are provided for enabling a user to access a plurality of local wireless computer networks from a mobile computing device, using a single wireless access account to pay for the access charges incurred at the plurality of local wireless computer networks.

### BRIEF DESCRIPTION OF THE DRAWINGS

FIG. 1 is a schematic diagram of a wireless network access system, according to one embodiment of the present invention.

FIG. 2 is a flowchart of a wireless network access method, according to one embodiment of the present invention.

FIG. 3 is a continuation of the flowchart of FIG. 2.

### DETAILED DESCRIPTION OF THE PREFERRED EMBODIMENTS

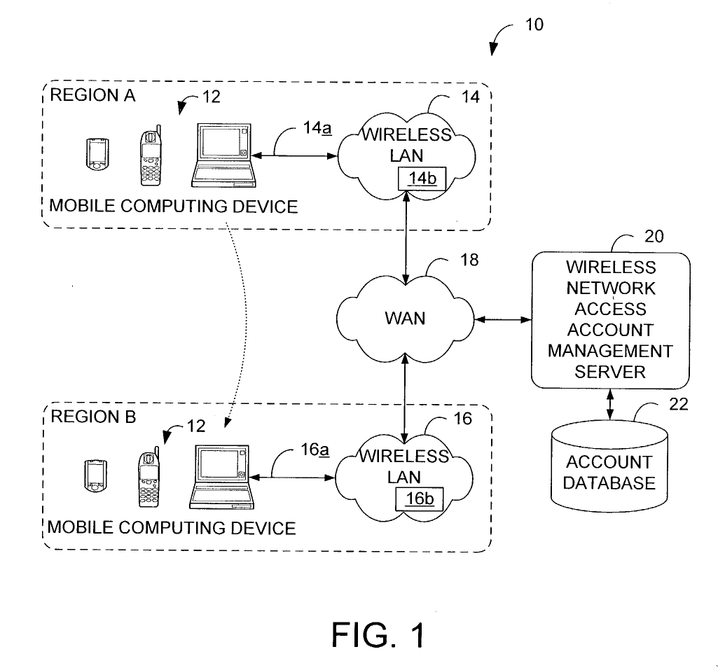

Referring initially to FIG. 1, a wireless network access system is shown generally at 10. System 10 typically includes a mobile computing device 12 configured to establish a first wireless network connection 14a with a first wireless local area network (LAN) 14 of first region A, and to establish a second, subsequent wireless connection 16a with wireless LAN 16 upon moving to region B. Connections 14a and 16a are alternatively referred to as communication links 14a and 16a, because they are typically used to exchange data between device 12 and wireless networks 14, 16.

Region A and B may be different geographic regions serviced by different wireless LAN service providers, or may be different territories or zones within the same wireless access service provider's coverage area. The system may include regions stretching across the United States or other geographic territory, to enable a user to travel virtually anywhere and access a wireless network using a single prepaid account.

System 10 further includes a wireless network access account management server 20 and associated account database 22 that are configured to communicate with wireless LANs 14, 16 via wide area network 18, and maintain a prepaid wireless network access account for a user of mobile computing device 12, which enables the user to pay for access time on each of networks 14, 16 using a single prepaid account. Account management server 20 is responsible for managing user accounts, profiles, user settings for levels of service, user credentials, user payment devices, user payment methods, etc. Thus the server 20 is configured to handle real-time payment to fund the account initially, add money to the account, and debit the account based on use in real time.

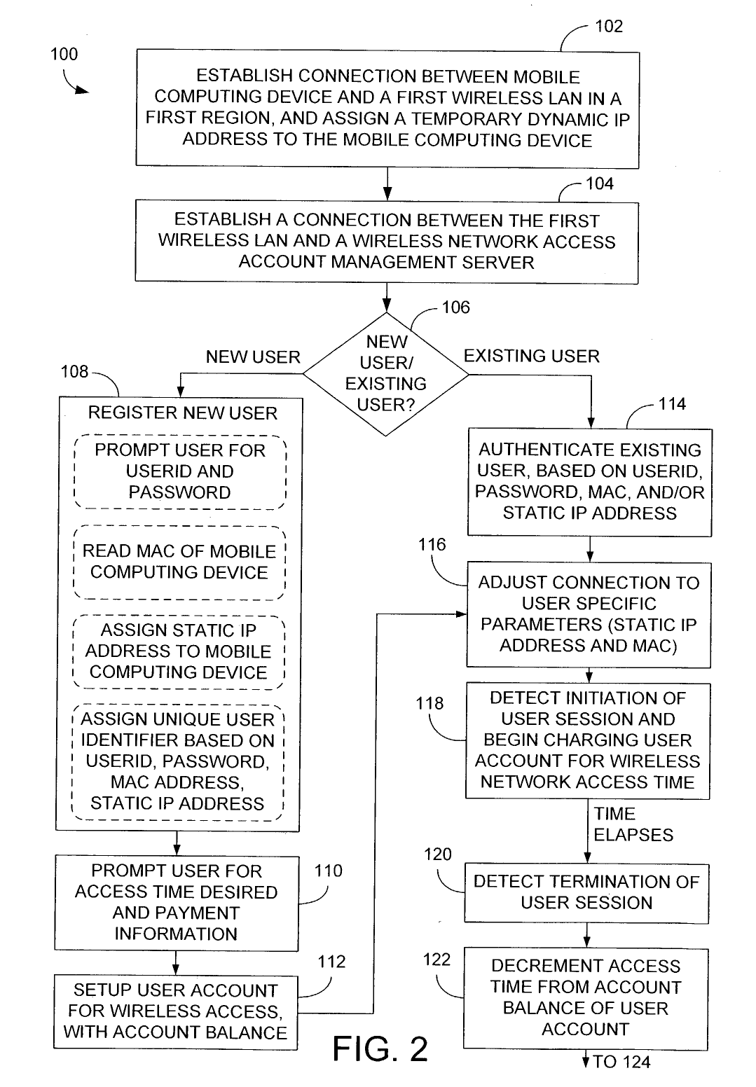

FIG. 2 shows a method 100 that may be implemented by the system described above. Method 100 typically includes, at 102, establishing a connection 14a between mobile computing device 12 and a first wireless LAN 14 in a first region A, and in the process, assigning a temporary dynamic IP address to the mobile computing device. At 104, the method includes establishing a connection between the first wireless LAN 14 and a wireless network access account management server 20. Typically, this connection is established by software 14b configured to run on wireless LAN 14. Software 14b is configured to communicate with the account management server, and send information about the user, such as a Media Access Control (MAC) address, assigned IP address, and user identity to the account management server. Corresponding client software 16b with similar functionality is provided on wireless LAN 16.

At 106, server 20 is configured to determine whether the user of mobile computing device 12 is a new user or not. Typically, this is accomplished by attempting to authenticate a user ID, password, MAC address, and IP address of the user. If the user is a new user, the method includes, at 108, registering the new user. This is typically accomplished by prompting the user for a user ID and password, reading a MAC address from the mobile computing device 12, assigning a static IP address to the mobile computing device and assigning a unique user identifier based on the user ID, password, MAC address, and IP address. The IP address typically only is valid for a finite period of time, and may be subject to renewal, or may not be routable outside of a particular wireless LAN 14 The user ID may be invisible to computers the outside the wireless LAN and/or account management server, and typically has meaning internally for management and communication purposes.

At 110, the method further includes prompting the user for an amount of access time that the user desires to add to the user's account, as well as payment information, such as a debit/credit card number. At 112, the method includes setting up a prepaid user account for wireless access, having an account balance incremented to the value requested by the user.

The method may also include defining user settings for a desired level of service for the user, for example, the user may sign up for premium high-speed access, and encrypted connections, etc. Future connections by the user will take place according to the user settings for the desired level of service. As the user requests a particular action, the account management server is configured to authorize the action based on the user settings.

If the user is an existing user, the method, at 114, includes authenticating the user based on user ID, password, MAC address, and/or static IP address previously assigned to the mobile computing device 12. This is typically accomplished by prompting the user for the user ID and password, and detecting the MAC address.

At 116, the method includes adjusting the connection to the mobile computing device 12 based on user specific parameters, such as the static IP address and MAC address.

At 118, the method includes detecting initiation of the user session and beginning to charge the user account for wireless network access time. Typically, this occurs as soon as the user is free to use the connection 14a to connect to WAN 18 and connect to third party servers to read email, surf the Internet, etc.

At 120, the method includes detecting termination of the user session on connection 14a, and at 122, the method includes decrementing the user account by a value based on the length of access time used by the user. The connection may be terminated at the user's request, at the system's request (e.g. when the account balance drops to zero), accidentally, or for some other reason.

The method may also include monitoring the account balance of the user's account, and, if the account balance drops below a predetermined threshold, such as 10 minutes, prompting the user to add more time to the account.

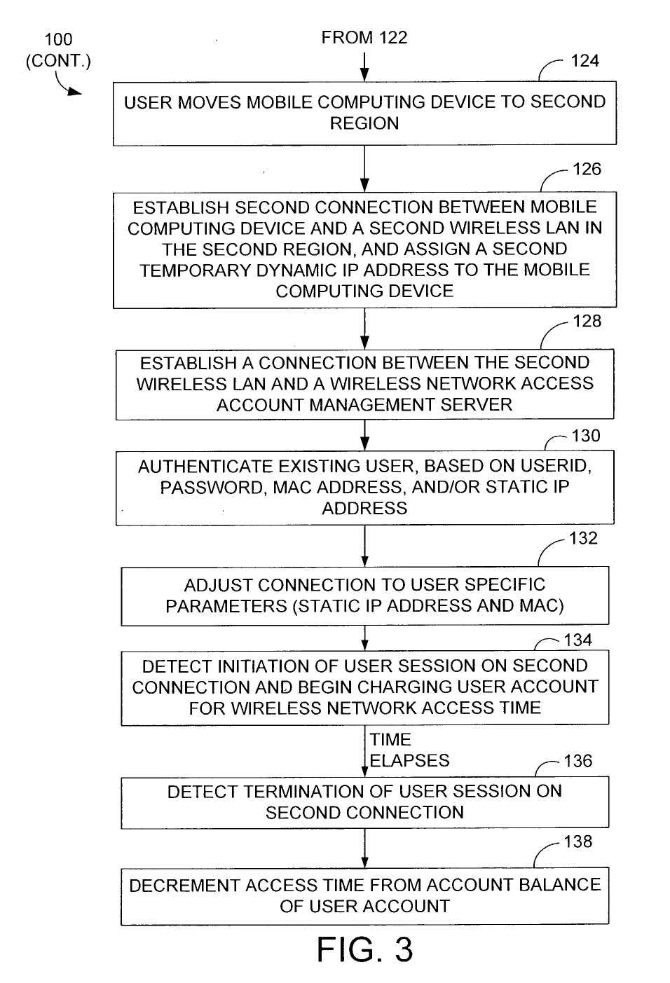

Turning now to FIG. 3, at 124 the method includes moving the mobile computing device 12 to a second region B. At 126 the method includes establishing a second connection between the mobile computing device and a second wireless LAN 16 in the second region B, and in the process, assigning a second temporary dynamic IP address to the mobile computing device.

At 128, the method includes establishing a connection between the second wireless LAN 16 and a wireless network access account management server 20, via WAN 18. At 130, the method includes authenticating the user of mobile computing device 12 as an existing user, based upon a user ID, password, MAC address and/or static IP address.

At 132, the method includes adjusting the connection between computing device 12 and wireless LAN 16 to be based on user specific parameters, such as the static IP address and MAC address. The method may also include authorizing a requested action based upon previously inputted user settings for a desired level of service. For example, the user may request a high speed connection, but the user's settings may indicate that the user is not authorized to connect at high speed.

At 134, the method includes beginning to charge the user account for wireless network access time. Again, this typically occurs as soon as the user has completed the authentication process and is free to use WAN 18 to connect to third party servers in order to read email, surf the Internet, etc.

At 136, the method typically includes detecting termination of the second connection to wireless LAN 16, and at 136, decrementing the account balance of the user's account on server 20. Typically the account balance is expressed in access time, e.g., 55 minutes of access time remaining. Alternatively, the account balance may be expressed in monetary units, such as $50 dollars remaining. This is useful where access time rates vary from region to region. Thus, $50 dollars may be the equivalent of 30 minutes of access time in one region, but 60 minutes of access time in another.

The above-described invention may be used conveniently by a user to enable payment for connection charges incurred at a plurality of fee-based wireless computer networks, using a single user account. By using a single user account, the user avoids the hassle of paying separately at each wireless LAN location. In addition, since the user account survives after termination of the connection, the user may save unused access time for a later session, saving the user money.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein.

It is claimed:

1. A wireless computer network access method, comprising:
providing a wireless network account management server configured to communicate with a plurality of fee-based wireless networks, each wireless network being configured to establish a wireless communication link to a mobile computing device;
setting up a user account on the wireless network account management server, the user account having an account balance;
determining access time used by a user of the mobile computing device at each of the plurality of wireless networks; and
decrementing the account balance of the user account for access time used at each of a plurality of wireless networks.

2. A wireless computer network access method, comprising:
setting up a user account for a user of a mobile computing device on a wireless network access account management server;
establishing a first wireless communication link between the mobile computing device of the user and a first wireless network;
measuring an amount of access time used by the user on the first communication link;
decrementing the account balance of the user account for the amount of access time used on the first communication link;
establishing a second wireless communication link between the mobile computing device of the user and a second wireless network;
determining an amount of access time used by the user on the second communication link; and
decrementing the account balance of the user account for the amount of access time used on the second communication link.

3. The method of claim 2, wherein establishing the first wireless communication link between the mobile computing device and the first wireless network further includes:
assigning a temporary dynamic IP address to the mobile computing device initially;
authenticating the user; and
adjusting the first communication link to the user-specific parameters.

4. The method of claim 3, wherein authenticating the user further includes authenticating the user based on a parameter selected from the group consisting of UserID, password, MAC and static IP address.

5. The method of claim 3, wherein determining an amount of access time used by the user on the first communication link includes:
detecting initiation of a user session on the first communication link;
detecting termination of the user session on the first communication link.

6. A wireless computer network access system, comprising:
an account management server configured to communicate with each of a plurality of fee-based wireless networks, each wireless network being configured to establish a respective connection with a mobile wireless computing device;
wherein the account management server is configured to set up a user account, the user account being configured to purchase access time for accessing each of the plurality of wireless networks from the mobile computing device; and
wherein the account management server is configured to decrement an account balance of the user account for the access time used by the user at each of the plurality of wireless networks.
